(19) United States
(12) Patent Application Publication
(10) Pub. No.: US 2014/0318876 A1
(43) Pub. Date: Oct. 30, 2014

(54) Kellams Receptacle Scale

(71) Applicant: Sandra Lynn Kellams, Schererville, IN (US)

(72) Inventor: Sandra Lynn Kellams, Schererville, IN (US)

(21) Appl. No.: 14/258,803

(22) Filed: Apr. 22, 2014

Related U.S. Application Data
(60) Provisional application No. 61/814,725, filed on Apr. 22, 2013.

(51) Int. Cl. G01G 23/00

(52) U.S. Cl. CPC G01G 23/005
USPC 177/45

(57) ABSTRACT

The Kellams Receptacle Scale, is a wheeled scale that weighs the contents loaded into industrial fifty five gallon receptacles. The scale emits an audible warning when weight exceeds a preset amount. A side panel comprises is a small liquid crystal display or LCD screen that shows the amount of weight measured. Next to this screen are directional buttons to preprogram the present invention with an acceptable weight.

### CLAIM OF PRIORITY

This patent application claims priority under 35 USC 119 (e) (1) from U.S. Provisional Patent Application Ser. No. 61/814,725 filed Apr. 22, 2013, of common inventorship herewith entitled, “Kellams Scale.”

### FIELD OF THE INVENTION

The present invention pertains to the field of waste containers, and more specifically to the field of scales for weighing waste receptacles.

### BACKGROUND OF THE INVENTION

The prior art has put forth several designs for weighing waste receptacles. Among these are:

U.S. Pat. No. 6,222,137 to Charles E. Handford describes a portable scale for weighing drums, cylinders and other containers. The scale is lightweight, easily transportable and due to the use of three load cells instead of the traditional four, it is highly accurate even on uneven floor surfaces. The weighing platform is low to the ground and has a loading ramp that makes easier placement of objects to be weighed.

U.S. Pat. No. 5,235,325 to James L. McCaughan, Jr. describes a weight alarm device for a trash container having a body with a top surface resiliently connected to a bottom surface, a switch attached to the body and responsive to relative movement between a top surface and a bottom surface, and an alarm electrically connected to the switch for producing a humanly perceivable signal when the relative movement between the top surface and the bottom surface exceeds a predetermined amount. The body has a shape adapted for receipt within the trash container. The top surface and the bottom surface have overlapping sides extending around the periphery of the surfaces. A coil spring is interposed between the top and bottom surfaces. The switch is a contact switch which is movable between a first position and an alarm sounding second position. An abutment member is connected to the bottom surface so as to contact the contact switch upon a movement of the top surface beyond a predetermined amount.

U.S. Pat. No. 4,889,290 to Robert M. Koffsky and Finn S. Pedersen describes a rotary grinder including a hopper for receiving waste through a door, which when closed, provides a fluid tight seal. A movable waste receptacle is provided beneath the grinder and is locked in place and weighed during the operation of the grinder. An iris diaphragm valve mates with the outlet from the grinder and, when in its open orientation, drops a sleeve into the waster receptacle thereby creating a sealed enclosure for the decontaminated waste material. Cutting blades employed by the grinder are identical and are provided with bearing shoulders which determine the amount of blade exposed when the blades are mounted on rotating arms of the grinder.

None of these prior art references describe the present invention.

### SUMMARY OF THE INVENTION

It is an object of the present invention to provide a wheeled scale to measure weight loaded into an industrial fifty five gallon garbage receptacle.

### BRIEF DESCRIPTION OF THE DRAWINGS

FIG. 1 is an illustrative prototypical side view showing a scale base, an LED display, weight limit settings and a speaker that emits an audible warning when weight limit is reached.

FIG. 2 is a prototypical full view of a receptacle inserted on the present invention.

FIG. 3 is an illustrative prototypical underneath view showing four wheels attached to a stabilizing wheel frame.

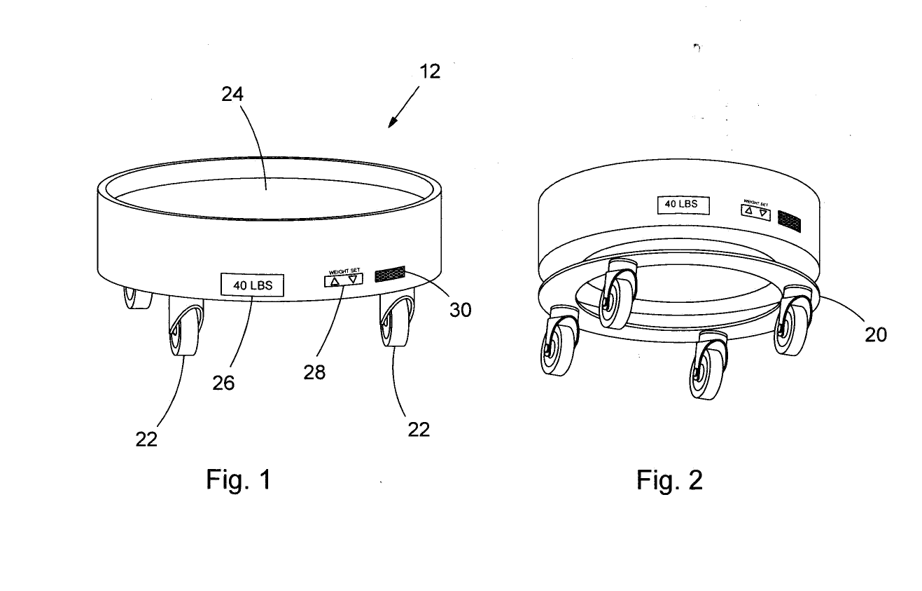

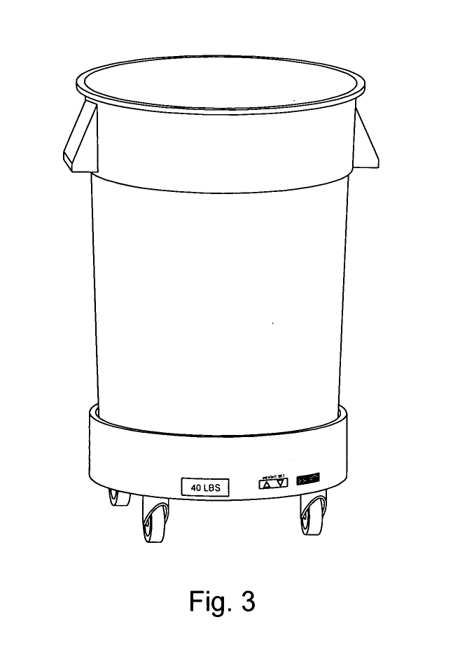

### DETAILED DESCRIPTION OF THE INVENTION

The most common type of nonfatal occupational health injuries involving lost work days are physical tears, sprains and strains. In the year twenty thousand ten, approximately seven hundred ninety nine thousand cases involving these type occupational injuries were recorded. Approximately three hundred eighty five cases were back injuries. Overexertion injuries result from excessive lifting, pushing, pulling, holding, carrying or throwing an object. These injuries generally are called musculoskeletal disorders or MSDs. MSDs involve nerves, tendons, muscles and supporting structures of one's body. Back strain occurs when muscle, ligaments or tendons in the back are damaged due to overstretching or overuse, resulting in strains, sprains and tears. Herniated disks are also a type of back injury found in workplace situations. To avoid workplace back injury, many companies implement an ergonomics program which focuses on redesigning their work environment and work tasks to reduce the hazards of lifting.

The present invention, hereinafter referred to as the Kellams Scale, or Kellams Receptacle Scale, is a wheeled scale that weighs the refuse loaded into industrial receptacles capable of holding approximately fifty five gallons. Emitting an audible warning when weight exceeds a preset amount, Kellams Scale prevents workplace injuries that occur as a result of attempting to empty excessively heavy refuse containers. Kellams Scale is a flat circular unit 12 with a diameter sized appropriately to sufficiently accommodate a wide bottom of a fifty five gallon container commonly used by restaurants, hotels and construction companies. Kellams Scale is manufactured with cast wheels 22, creating a dolly 20 upon which a garbage receptacle is placed. On the surface of the present invention is a weight plate 24 comprised of a series of magnetic sensors to measure weight placed upon said surface. On a side panel of Kellams Scale is a small liquid crystal display or LCD screen 26 that shows the amount of weight measured. Next to this screen are directional buttons 28 to preprogram the present invention with an acceptable weight for safely transporting the loaded garbage receptacle. When this preset weight is exceeded, Kellams Scale emits a warning buzzer or alarm from an integrated external speaker 30 to inform a user that the refuse contained within the receptacle is over the preset weight limit. This buzzer alarm continues to sound until excess refuse is pulled from the receptacle and the total weight registers at or below the preset weight. The scale's alarm begins sounding when the loaded weight passes the preset amount by as much as an ounce. With the receptacle's contents removed to a safe heft, the garbage is emptied without any harm coming to the worker. Kellams Scale's wheel capability further enhances safety from injury by permitting a worker to simply roll the entire receptacle to a Dumpster and empty its contents into the dumpster.

Kellams Scale is extremely easy to operate. Transporting heavy refuse receptacles on this portable weighing platform is a highly functional addition to any business that deals with large amounts of refuse collection on a daily basis. The present invention promotes workplace safety resulting in workman's compensation claims decreasing steadily and leading to higher worker productivity and money savings for the business. Kellams Scale is functional for home use as well, ensuring that large garbage and recycling containers are filled to safe emptying loads for a homeowner. Made of durable and high quality materials, Kellams Scale will withstand years of continued use.

Although this invention has been described with respect to specific embodiments, it is not intended to be limited thereto and various modifications which become apparent to the person of ordinary skill in the art are intended to fall within the spirit and scope of the invention as described herein taken in conjunction with the accompanying drawings and the appended claims.

1. A wheeled scale to measure weight loaded into a receptacle, comprising: a wheeled scale that weighs the refuse loaded into receptacles, further comprising a speaker capable of emitting an audible warning when weight exceeds a preset amount, wherein the scale comprises a flat circular unit having cast wheels, creating a dolly upon which a receptacle is placed.

2. The wheeled scale of claim 1 further comprising a side panel having a liquid crystal display or LCD screen that shows the amount of weight measured.

3. The wheeled scale of claim 2 further comprising directional buttons to preprogram the desired weight to activate the audible warning.

4. The wheeled scale of claim 1 wherein the audible alarm continues to sound until excess refuse is pulled from the receptacle and the total weight registers at or below the preset weight.

5. The wheeled scale of claim 1 wherein the receptacle is an industrial fifty five gallon receptacle.

6. The wheeled scale of claim 2 wherein the receptacle is an industrial fifty five gallon receptacle.

7. The wheeled scale of claim 3 wherein the receptacle is an industrial fifty five gallon receptacle.
